(19) United States
(12) Patent Application Publication
(10) Pub. No.: US 2005/0197062 A1
(43) Pub. Date: Sep. 8, 2005

(54) Method and apparatus for transponder initiated messaging

(76) Inventor: Peter Sprogis, London (GB)

Correspondence Address: Gibso, Dunn & Crutcher LLP, Suite 4100, 1801 California Street, Denver, CO, 80202, US

(21) Appl. No.: 10/791,267

(22) Filed: Mar. 2, 2004

(51) Int. Cl. H04Q 7/20

(52) U.S. Cl. 455/41.2; 455/41.1

(57) ABSTRACT

A messaging system utilizing radio frequency identification (“RFID”) wherein a RFID tag is interrogated by a RFID transmitter-receiver. The RFID tag sends a message to the RFID receiver in the form of a prompt. The prompt provides directions to obtain additional information, such as advertising information. The additional information may include information about the article on which the RFID tag is placed. The additional information may be obtained, at the option of the person receiving the prompt, by a variety of means, such as dialing a telephone number, sending a SMS text message, sending an e-mail or accessing a website.

### FIELD OF THE INVENTION

This invention relates to radio frequency identification (“RFID”) systems wherein a transponder sends a message to a receiver-transmitter that then provides a prompt for the user to, at his or her option, obtain additional information, preferably information about the article to which the transponder is attached. Specifically, the invention relates to a method for providing on-demand advertising to a consumer in response to the consumers' acceptance of a prompt that is provided by the receiver-transmitter detecting the RFID tag.

### BACKGROUND

Evolving technologies allow products to be tagged with inexpensive transponders and then tracked by devices that can read the information encoded into the transponder. Radio frequency identification (“RFID”) uses low-powered radio transmitters to read data stored in a transponder at distances up to 200 feet away. Present applications of this technology include tracking assets, managing inventory, automatic vehicle identification, highway tolls and authorizing payments. RFID technology is also used by certain automobile manufacturers to provide electronic keys to their automobiles.

RFID systems originated in the 1940s when the U.S. government used transponders to distinguish between friendly and enemy aircraft. Aircraft still utilize transponders today for aircraft tracking. In addition to tracking aircraft, the airline industry, along with the FAA has used RFID tags to route baggage and increase air security. In the 1970s, the U.S. government used RFID systems for tracking livestock and nuclear material. Companies such as McDonald's and Exxon Mobile have tested RFID chips to allow customers to pay for food or gas.

RFID technology is known to those skilled in the art. Commercial utilizations typically operate in a number of unlicensed frequency bands, with 125 KHz and 13.56 MHz being the most common. The greater the bandwidth the more information a RFID tag can hold. For instance, a 13.56 MHZ tag can hold as much as 2,000 bits of data, roughly 30 times the information that can be held on a 125 KHz tag. Active RFID tags are equipped with a battery that allows an active tag to transmit a signal to a reader. These tags often provide the greatest range, up to 200 feet, but are more expensive than other tags. Passive RFID tags are not battery powered. They draw power from the electromagnetic waves emitted from the receiver-transmitter. The read range of these tags is generally under three meters and their cost is generally under a dollar. Semi-passive RFID tags have batteries like active RFID tags, but the battery is only used to power the tag's microchip circuitry, it does not power the transmission from the tag to the reader. Semi-passive tags also have longer read ranges than passive tags.

One example of RFID use is inventory control. In this application, a RFID tag is placed on the item to be tracked. Up to 2,000 bits of data are stored on a memory chip that is housed in a button or integrated circuit card. Tags can also be etched on a substrate that is then embedded in a paper or plastic tag. The information stored on the tag may include a unique product identification code, the place of product manufacture and the place of sale. The tag may include a battery or it may be passive. A RFID transmitter-receiver or reader is utilized that contains a transmitter, receiver and digital control module connected to a transmitting antenna. When the control module senses a tag, it interrogates the tag (after awakening the tag if passive), decodes the data and typically passes that data on to a host system by way of wired or wireless communication. The host system assimilates the data received from the product tags and the data is used to track product inventory and sales.

The majority of RFID tags are write-once/read-only, but others offer read/write capability such that the information contained on the tag can be rewritten. For instance if tracking an item in transit, the information can be rewritten as the item travels along its route or is rerouted. RFID readers may be hand-held and wireless.

Numerous companies have developed RFID technology, including Texas Instruments (see U.S. Pat. Nos. 5,347,280 and 5,541,604), IBM (see U.S. Pat. Nos. 5,528,222; 5,550,547; 5,521,601; and 5,682,143), Motorola/Indala (see U.S. Pat. Nos. 5,378,880 and 5,565,846), and Mikron/Philips Semiconductors (see U.S. Pat. Nos. 4,442,507; 4,796,074; 5,095,362; 5,296,722; and 5,407,851). In addition, RFID technology and tracking systems are described in numerous additional patents, including U.S. Pat. Nos. 6,424,262 and 6,484,780 to Garber, assigned to 3M (describing the use of RFID to track library materials); U.S. Pat. No. 6,100,804 to Brady, assigned to Intecmec (describing a RFID system employing a thin, flexible RFID tag and integrated antenna); and U.S. Pat. No. 6,563,417 to Shaw, assigned to Identec Solutions (describing a RFID method of tracking products moving along a distribution path). Each of the above referenced patents and their disclosures regarding RFID technology are incorporated herein by reference.

Examples of RFID technology and uses can also be found in the June 2003 Equity Research of Bear Stearns, titled Supply-Chain Technology: Track(ing) to the Future, The Impending RFID-based Inventory Revolution, which is also incorporated herein by reference.

### SUMMARY OF THE INVENTION

The invention disclosed expands on the current uses of RFID technology and discloses a unique and beneficial method for allowing users to selectively receive certain advertising type information. A prompt to ask for additional information, or a unique code associated with the prompt, is encoded into a RFID tag that is placed on an article. When the article comes within range of a RFID reader, the reader reads the tag and displays the prompt. Persons can then accept the prompt and ask for and receive advertising information, including information relating to the tagged article. The persons ask for the information by using a telephone or web-enabled type device which communicates with a computer or server whereon the additional information is stored.

### BRIEF DESCRIPTION OF THE DRAWINGS

FIG. 1 depicts a RFID tag affixed to an automobile that, when interrogated, sends a signal to a RFID reader in the form of a prompt to dial a telephone number in order to receive additional information about the automobile. The telephone number is dialed and additional information stored on a server is provided to the telephone by way of conventional telephonic communication.

FIG. 2 depicts a RFID tag affixed to an item of merchandise in a store. When interrogated, the tag provides a prompt to a RFID reader that provides the consumer with a website address, via a universal resource location address, or link. The consumer can access with a device that can access the World-Wide Web to obtain additional information about the merchandise.

FIG. 3 depicts a RFID reader that communicates with a central controller or computer to provide a prompt and advertising to the RFID reader when the reader detects a RFID Tag.

### DETAILED DESCRIPTION OF THE INVENTION

The present invention discloses a method of providing to consumers an opportunity to receive information when the consumer comes within a certain proximity of a product. The invention further provides that the consumer is not simply bombarded with the advertising information, but instead is provided with a prompt whereby the consumer may at his or her option selectively choose the information that he or she wishes to receive. The information may be accessed by a variety of mediums, for example by calling a telephone number, accessing a website, receiving an e-mail, or viewing an advertisement on a RFID receiver.

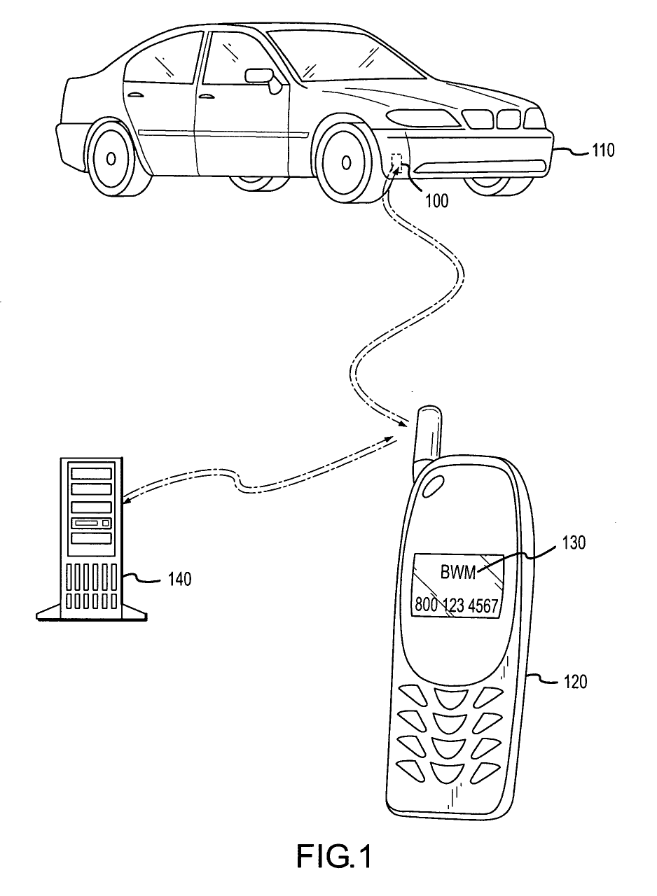

FIG. 1 provides an illustration of one preferred embodiment of the invention. In FIG. 1, a RFID tag (100) is affixed to an automobile (110). In such an embodiment, longer range signaling utilizing an active, high frequency RFID tag is preferably used. One example of such a tag is Model EXR1, manufactured by RFID, Inc., which is an active tag operating at 315 MHz with a range of up to 200 feet. The random access memory of the RFID tag is encoded with a prompt that can direct a user of a compatible RFID transmitter-receiver to additional information about the vehicle or possibly additional information that is unrelated to the vehicle. The RFID transmitter-receiver or reader (120) receives the prompt from the tag and displays it on the transmitter-receiver display (130). The transmitter-receiver may be a separate handheld device, such as the Model EXR1 reader offered by RFID, Inc., or, given the trend in the industry to design smaller and smaller readers, see for example the RFID, Inc. Model 3020 Series Microreader that measures only 1″×2″×0.25″, the transmitter-receiver could be incorporated into a handheld device such as a cellular telephone, personal digital assistant or wireless e-mail device. In a preferred embodiment, the reader signals the consumer, via a beep, vibration or other method, when a tag is read.

The RFID tag (100) may, for example, provide the consumer with a telephone number prompt (130). The consumer can call that telephone number to receive a prerecorded or live message about the automobile, including for example, information about ongoing promotions and nearby dealerships. Instead of providing a telephone number prompt, the RFID tag may be coded such that upon reading the tag the transmitter-receiver will display a website address that the consumer may access for further information about the tagged automobile. Alternately, the prompt could be for receipt of information by way of SMS text messaging or e-mail. For example, the transmitter-receiver displays an e-mail address. The consumer sends an e-mail to the displayed address and a reply e-mail is sent back to the consumer containing additional information about the tagged automobile.

In this embodiment, a tag and transmitter-receiver would be utilized of sufficient range such that a consumer who was able to see the automobile of interest, up to 30 or more feet away from the vehicle, would be able to receive the prompt. Tags of this capability, generally of active or semi-passive capabilities, are available from a variety of vendors in addition to RFID, Inc. mentioned above, such as Texas Instruments, Phillips, Infineon, Alien Technologies and others. It should be noted that the tag need not stay within range of the transmitter-reader beyond the time needed for the initial prompt signal to be received. If the tag thereafter moved out of range the consumer would still be able to access the additional information via his or her cellular telephone or web-enabled device because that additional information would be provided independently of the RFID tag via a call center, pre-recorded message or server. In a preferred embodiment, the additional information is hosted on a server (140) and provided to the consumer on whatever device the consumer uses to respond to the prompt and to access the server.

In a preferred embodiment, the RFID reader is incorporated into a cellular telephone or web-enabled device and is also provided with a switch that would allow the user to turn the RFID reader off when the user did not wish to be notified that information about RFID tagged articles was available. RFID readers typically come with an on/off capability.

In another embodiment of the present invention RFID tags are placed on products such as automobiles. Instead of being carried by individuals or incorporated into hand-held devices, RFID readers capable of reading such tags are dispersed about an area. The RFID readers are connected to displays that are within view of the general public. When a RFID tag comes within range of the RFID reader it is interrogated and transmits an encoded prompt to the RFID reader. The RFID reader reads the prompt and displays it on the display that is in public view. For example, a tag that is affixed to a BMW automobile might be encoded with a prompt to call a telephone number to learn more about BMW automobiles. This prompt would be displayed on the public display when the BMW was within range of the RFID reader. Consumers would see the prompt and make a decision of whether or not to dial the number to learn more about BMWs. Because the consumer is likely to see both the tagged item, the BMW, and the display offering to provide additional information about the tagged item, this type of advertising is more effective than a billboard or bench advertisement that does not have any link to the actual item being advertised.

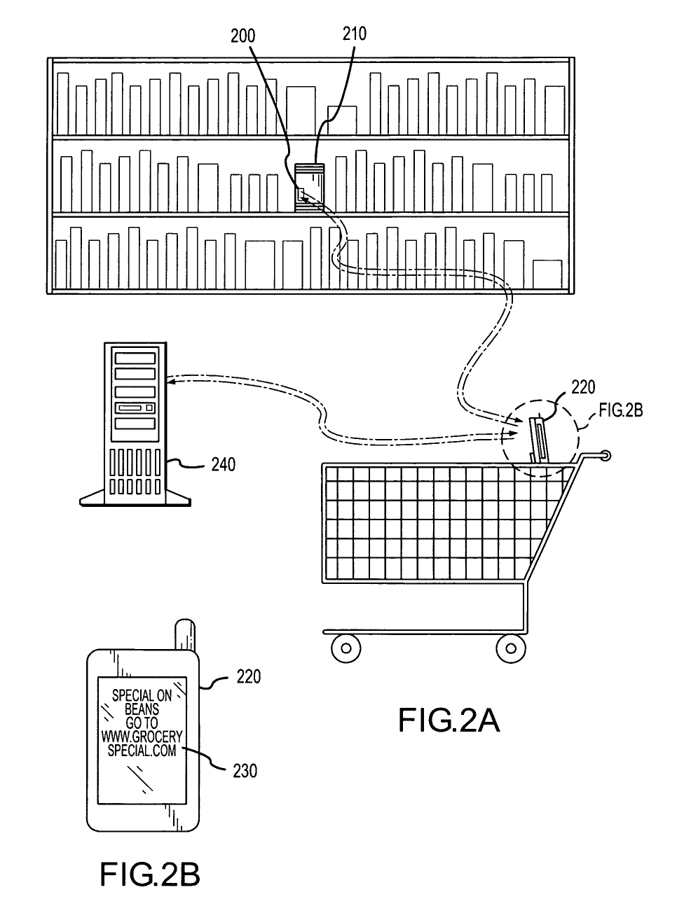

Another embodiment of the present invention is employed by a business such as a grocery or retail store. The store places RFID tags on various merchandise that it sells. The tags are coded with unique merchandise codes that, when read by a reader-transmitter, provide a prompt to the consumer to receive more information about the merchandise. For example, as in FIG. 2, a tag (200) is placed upon a can of beans (210) that is in an aisle of a grocery store. The grocery store patron is provided with a RFID transmitter-reader (220) upon entry into the store. As shown in FIG. 2, the receiver-transmitter could be attached to a grocery cart. It could of course also be hand-held or otherwise made available to the store patron. As the patron comes within range of the RFID tag on the can of beans, say for example within 2 meters, the reader-transmitter (220) interrogates the passive tag (200), which wakes up and sends its information to the reader-transmitter. Based upon the signal from the tag, the reader-transmitter displays a prompt to the patron (230). The prompt could be provided in many ways. For instance, the RFID tag on the can of beans could be encoded with the prompt so that it is read directly by the reader-transmitter. This would work well with a prompt that was a telephone number or website address because the information provided by the telephone number or website could be changed when the store wished to provide patrons with different information about the merchandise without changing the tag. In this implementation the RFID tag could be a read-only tag with the telephone number or website address encoded thereon. The information is preferably stored on a server (240) or servers that are maintained by the store or a third party.

Another method of providing the prompt is to use a read/write RFID tag that contained the additional information about the beans. In this embodiment, the tag provides the reader-transmitter with the advertising information, for instance an initial prompt of “Special” would be displayed on the reader-transmitter. The patron then indicates to the reader-transmitter by pushing an accept button, for example, if he wanted to view what the special was. Upon the patron accepting the additional information, the reader-transmitter, would display it, for example: “string beans—2 for 1.” The patron could then decide to purchase two cans of beans at this special price. In this implementation it would be preferred to use RFID tags that could be rewritten so that the information about the products that is sent to the receiver-transmitter can be changed as the store desired.

Yet another method of providing the prompt is to use a RFID tag that simply contained the unique product identification code. In this embodiment, the RFID receiver-transmitter reads the product identification code and then accesses a prompt stored in the memory of the receiver-transmitter that is associated with that code. The RFID receiver-transmitter provides the prompt to the patron who can either accept the prompt and be directed to further information about the product, or ignore the prompt which is then replaced with another prompt when another RFID tag came within range of the receiver-transmitter. In cases where multiple RFID tags are in range of the receiver-transmitter at the same time, the receiver-transmitter is programmed with a hierarchy that determines which prompt to display first, second, third, etc. Existing RFID non-collision technology that allows multiple tags to be read substantially simultaneously is known in the art.

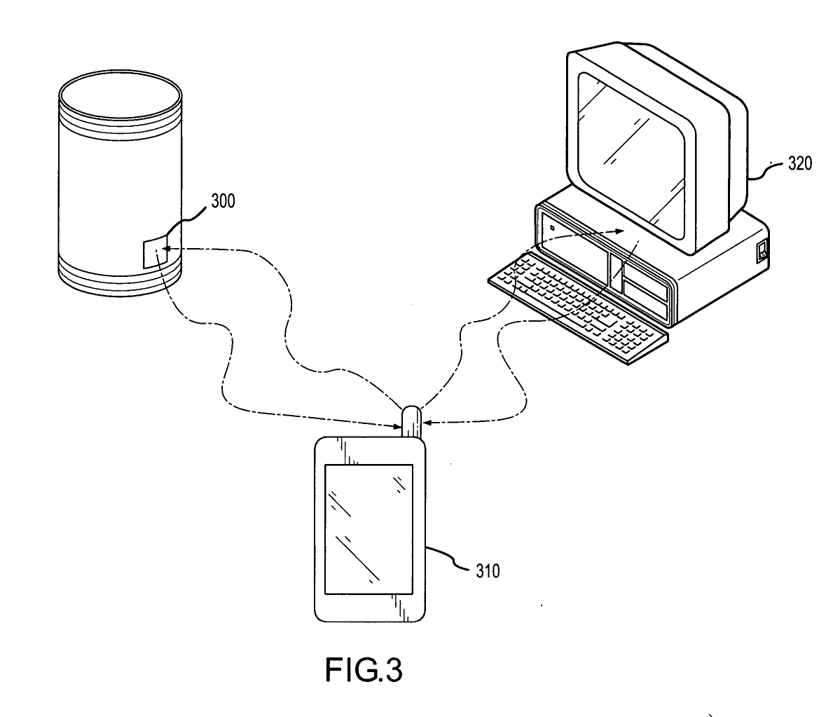

In yet another embodiment, set forth in FIG. 3, a RFID tag (300) is encoded with a unique product identification code. The receiver-transmitter (310) interrogates the tag and receives the code. If the consumer accepts the prompt, the code is sent from the receiver-transmitter to one of one or more central computers (320) throughout the store. The central computer receives the product code and accesses the prompt that is associated with that code. The prompt is then sent back to the receiver-transmitter and displayed to the consumer who may access the additional information, preferably stored on the central computer (320), directly with the RFID reader. While this embodiment, employing a central computer such as used in the present inventory control utilization of RFID technology, is encompassed within the present invention, one of the beneficial aspects of the present invention is that no central controller/computer is required. Once the signal is provided to the reader by the tag the accessing of the additional information may be accomplished independently of the RFID system through standard wire or wireless communication.

A further embodiment of the present invention is in the context of dating. Individuals sign-up to participate. The participating individuals provide personal information such as height, weight, hair color, interests, occupation, etc., to a service that hosts the personal information on a computer server and associates the personal information with a unique identification code that is embedded into a RFID chip. The RFID chip is then provided to the participant in a membership card, for example, or perhaps in a RFID reader.

When the participant's RFID tag or chip comes within range of another participant's RFID reader, it is interrogated and read. The RFID reader displays a prompt for more information about the person. The prompt, for example, could read: “I'm Kim—learn more at 800 Call Kim.”

Alternately, the RFID reader can communicate directly with a host computer if the system is employed in a relatively closed environment such as a bar. The tag sends the code to the reader. The reader displays a prompt for more information. If the prompt is accepted, the host computer sends additional information directly to the RFID reader.

This provides a new method for individuals to learn about others in their vicinity without the need for verbal communication. The method functions well in a bar or other social environment.

The present invention can also be incorporated into law enforcement. For example, license plates can include RFID tags that contain a unique vehicle identification code. Police cars and/or police officers carry RFID readers to interrogate vehicles for their identification code when they come within range. Then, for example, if a police offer pulled a vehicle over the officer's RFID reader provides a prompt asking if the police officer wants to obtain information about the vehicle. If the police officer accepts the prompt, the vehicle's existing radio or computer system sends the unique vehicle identification code to a database containing information about registered vehicles, such as date of last registration, drivers' address, and possible arrest warrants, etc. The database associates the unique vehicle identification code with the information in the database about the vehicle and sends that information to the police officer. In this way a police office has nearly instantaneous information about a vehicle of interest without the need to read and transmit a license plate number. Similar applications can be envisioned in connection with customs inspections or other fields related to homeland security.

These are just a few examples of embodiments of the present invention. It will be appreciated that the invention covers many other embodiments as well. The invention can be utilized on a variety of products and in a variety of ways. The examples listed above are intended to enable others skilled in the art to appreciate and practice the invention's unique application of RFID technology. The invention is not limited to the examples above, its scope is defined by the following claims.

1. A method of providing messaging comprising:
a. placing a RFID tag, encoded with a prompt for additional information, on an object;
b. receiving information from said RFID tag with a RFID reader;
c. transmitting commands between said RFID tag and said RFID reader with an antenna;
d. displaying said prompt to enable access to said additional information.

2. The method of claim 1 wherein said prompt includes a telephone number.

3. The method of claim 1 wherein said prompt includes an Internet address or website link.

4. The method of claim 2 wherein said user, upon dialing said telephone number, is provided information about the RFID tagged article.

5. The method of claim 3 wherein said user, upon accessing the website identified by said Internet address or website link, is provided information relating to the RFID tagged article.

6. The method of claim 1 wherein said prompt provides directions to said user to, at the user's option, request advertising information related to the article on, in or near which the RFID tag is located.

7. The method of claim 1 wherein said RFID reader may be turned off and not receive any prompt from said RFID Tag while turned off.

8. The method of claim 6 wherein the directions include a telephone number.

9. The method of claim 6 wherein the directions include an Internet address or website link.

10. The method of claim 6 wherein said advertising information is sent to said user upon said user accepting said prompt.

11. A messaging method comprising:
a. encoding a RFID tag with a unique identification code that provides direction to information about a product;
b. receiving said unique identification code from said RFID tag on a RFID reader;
c. transmitting and receiving information between said RFID tag and RFID reader on an antenna; and
d. utilizing said unique identification code to access and display said direction to information.

12. The system of claim 11 wherein said direction to information includes a telephone number.

13. The system of claim 11 wherein said direction to information includes an Internet address or website link.

14. The system of claim 12 wherein said direction to information is followed by dialing said telephone number and information is provided to the dialing telephone.

15. The system of claim 13 wherein said direction to information is accepted by entering the Internet address or Internet link into a web-enabled device and said Internet address or Internet link leads to a website containing advertising information.

16. The system of claim 11 wherein said direction to information provides directions to said user to, at the user's option, request advertising information.

17. The system of claim 16 where said advertising information relates to the product on, in or near which said RFID tag is affixed or incorporated into.

18. The system of claim 11 wherein said RFID reader may be turned off and thereby not receive any prompts from said RFID Tag.

19. A method of providing advertising comprising:
a. encoding a RFID tag with a prompt that provides directions to advertising information;
b. equipping a plurality of RFID readers with antennae for receiving transmissions from said RFID tags and dispersing said RFID readers throughout an area;
c. transmitting a prompt from said RFID tag to said RFID reader; and
d. displaying said prompt.

20. The method of claim 19 further comprising following said directions to advertising information and being provided advertising information about the product to which the RFID tag is affixed or incorporated into.

21. The method of claim 19 wherein said prompt includes a telephone number.

22. The method of claim 19 wherein said prompt includes an Internet address or website link.

23. The method of claim 19 wherein said advertising information is provided by way of e-mail.

24. The method of claim 19 wherein said advertising information is provided by way of text messaging.

25. The method of claim 19 wherein said advertising information is provided by way of an Internet website.

26. The method of claim 19 wherein said advertising information is provided by way of telephonic transmission.

27. The method of claim 19 wherein said RFID reader may be placed in an off or standby mode whereby it does not receive a prompt from said RFID Tag.

28. A method of providing information about a person comprising:
a. encoding a RFID tag with a unique code;
b. receiving said unique code by a RFID reader;
c. displaying a prompt that provides directions to access information about the person carrying the RFID tag;
d. following said directions and providing information about the person carrying the RFID tag.

29. The method of claim 28 wherein said directions include a telephone number.

30. The method of claim 28 wherein said directions include an Internet address or website link.

31. An apparatus for providing messaging comprising:
a. a RFID tag;
b. a RFID reader for receiving information from said RFID tag;
c. an antenna to transmit commands between said RFID tag and said RFID reader;
d. a display; and
e. a prompt displayed by the RFID reader to enable a user to access additional information.

32. The apparatus of claim 31 wherein said prompt includes a telephone number.

33. The apparatus of claim 31 wherein said prompt includes an Internet address or website link.

34. The apparatus of claim 32 wherein said user, upon dialing said telephone number, is provided information about the RFID tagged article.

35. The apparatus of claim 33 wherein said user, upon accessing the website identified by said Internet address or website link, is provided information relating to the RFID tagged article.

36. The apparatus of claim 31 wherein said prompt provides directions to said user to, at the user's option, request advertising information related to the article on, in or near which the RFID tag is located.

37. The apparatus of claim 31 wherein said RFID reader may be turned off and not receive any prompt from said RFID Tag while turned off.

38. The apparatus of claim 36 wherein the directions include a telephone number.

39. The apparatus of claim 36 wherein the directions include an Internet address or website link.

40. The apparatus of claim 36 wherein said advertising information is sent to said user upon said user accepting said prompt.

41. A messaging apparatus comprising:
a. a RFID tag encoded with a prompt that provides direction to information;
b. a RFID reader for receiving said prompt from said RFID tag;
c. an antenna to transmit and receive information between said RFID tag and RFID reader; and
d. a display to display said prompt.

42. The apparatus of claim 41 wherein said prompt includes a telephone number.

43. The apparatus of claim 41 wherein said prompt includes an Internet address or website link.

44. The apparatus of claim 42 wherein said prompt is accepted by dialing said telephone number and information about the RFID tagged article is provided to the dialing telephone.

45. The apparatus of claim 43 wherein said prompt is accepted by entering the Internet address or Internet link into a web-enabled device and said Internet address or Internet link leads to a website containing advertising information about the RFID tagged article.

46. The apparatus of claim 41 wherein said prompt provides directions to said user to, at the user's option, request advertising information.

47. The apparatus of claim 41 wherein said RFID reader may be turned off and thereby not receive any prompts from said RFID Tag.

48. An apparatus for providing advertising comprising:
a. a RFID tag;
b. a plurality of RFID readers equipped with antennae for receiving transmissions from said RFID tags;
c. said RFID tag transmitting a prompt that provides directions to advertising information; and
d. said RFID reader displaying said prompt.

49. The apparatus of claim 48 further comprising following said directions to advertising information and being provided advertising information about the product to which the RFID tag is affixed or incorporated into.

50. The apparatus of claim 48 wherein said prompt includes a telephone number.

51. The apparatus of claim 48 wherein said prompt includes an Internet address or website link.

52. The apparatus of claim 48 wherein said advertising information is provided by way of e-mail.

53. The apparatus of claim 48 wherein said advertising information is provided by way of text messaging.

54. The apparatus of claim 48 wherein said advertising information is provided by way of an Internet website.

55. The apparatus of claim 48 wherein said advertising information is provided by way of telephonic transmission.

56. The apparatus of claim 48 wherein said RFID reader may be placed in an off or standby mode whereby it does not receive a prompt from said RFID Tag.
